(19) United States
(12) Patent Application Publication
(10) Pub. No.: US 2026/0300504 A1
(43) Pub. Date: Oct. 1, 2026

(54) VULNERABILITY ANALYSIS SYSTEM AND VULNERABILITY ANALYSIS METHOD

(71) Applicant: Panasonic Automotive Systems Co., Ltd., Kanagawa (JP)

(72) Inventors: Yuishi TORISAKI, Osaka (JP); Shoichiro SEKIYA, Osaka (JP); Tomoyuki HAGA, Nara (JP)

(73) Assignee: Panasonic Automotive Systems Co., Ltd., Kanagawa (JP)

(21) Appl. No.: 19/443,688

(22) Filed: Jan. 8, 2026

(30) Foreign Application Priority Data
Mar. 26, 2025 (JP) 2025-051874

(51) Int. Cl. G06F 21/57

(52) U.S. Cl. CPC G06F 21/577; G06F 2221/033

(57) ABSTRACT

Vulnerability analysis system includes: vulnerability information receiver that receives vulnerability information regarding the vulnerability of a monitoring target; vulnerability analyzer that waits for a predetermined period of time after the vulnerability information is received, and when a new item of vulnerability information is received while waiting, collectively analyzes two or more items of vulnerability information among a plurality of items of vulnerability information that have been received before the predetermined period of time elapses; and display outputter that outputs an analysis result obtained by vulnerability analyzer.

### CROSS REFERENCE TO RELATED APPLICATION

The present application is based on and claims priority of Japanese Patent Application No. 2025-051874 filed on Mar. 26, 2025.

### FIELD

The present disclosure relates to a vulnerability analysis system and a vulnerability analysis method that analyze vulnerability of a monitoring target.

### BACKGROUND

Patent Literature (PTL) 1 discloses a technique for receiving vulnerability information and analyzing vulnerability.

### CITATION LIST

### Patent Literature

PTL 1: Japanese Unexamined Patent Application Publication No. 2024-68923

### SUMMARY

However, the technique disclosed in PTL 1 can be improved upon.

Therefore, the present disclosure provides a vulnerability analysis system and the like capable of improving upon the above related art.

A vulnerability analysis system according to the present disclosure is a vulnerability analysis system that analyzes vulnerability of a monitoring target, the vulnerability analysis system including: a vulnerability information receiver that receives vulnerability information regarding the vulnerability of the monitoring target; an analyzer that waits for a predetermined period of time after the vulnerability information is received, and when a new item of vulnerability information is received while waiting, collectively analyzes two or more items of vulnerability information among a plurality of items of vulnerability information that have been received before the predetermined period of time elapses; and an outputter that outputs an analysis result obtained by the analyzer.

A vulnerability analysis method according to the present disclosure is a vulnerability analysis method executed by a vulnerability analysis system that analyzes vulnerability of a monitoring target, the vulnerability analysis method including: receiving vulnerability information regarding the vulnerability of the monitoring target; waiting for a predetermined period of time after the vulnerability information is received; collectively analyzing two or more items of vulnerability information among a plurality of items of vulnerability information that have been received before the predetermined time elapses when a new item of vulnerability information has been received while the waiting; and outputting an analysis result obtained in the analyzing.

It should be noted that these general or specific aspects may be realized by a system, a method, an integrated circuit, a computer program, or a computer-readable recording medium such as a CD-ROM, or may be realized by any combination of a system, a method, an integrated circuit, a computer program, and a recording medium.

According to the vulnerability analysis system and the like according to one aspect of the present disclosure, the above related art can be further improving upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of a vulnerability analysis system according to an embodiment.

FIG. 2 is a flowchart illustrating an example of the operation of the vulnerability analysis system according to the embodiment.

FIG. 3 is a diagram illustrating an example of vulnerability information.

FIG. 4 is a diagram illustrating an example of consolidated vulnerability information.

FIG. 5 is a flowchart illustrating an example of a vulnerability analysis method according to another embodiment.

### DESCRIPTION OF EMBODIMENTS

When vulnerability information is received continuously, for example, multiple reports may be intensively made for the same software (CPE: Common Platform Enumeration), and in the technology disclosed in PTL 1, vulnerability risk analysis is performed individually each time vulnerability information is received. If vulnerability information is sequentially processed each time it is received, there is a problem in that it is not possible to analyze the mutual impact of each vulnerability. In addition, in order to analyze the mutual impact of each vulnerability, there is a problem in that it is necessary to perform multiple re-analyses depending on the combination of vulnerabilities, which increases processing load, and there is a problem in that the analysis results are obtained for each of the multiple re-analyses, which makes the handling of the analysis results complicated. Hereinafter, vulnerability analysis system and the like that can efficiently analyze continuously received vulnerability information will be described.

Hereinafter, embodiments will be specifically described with reference to the drawings.

It should be noted that the embodiments described below are comprehensive or specific examples. The numerical values, shapes, materials, components, arrangement positions and connection forms of the components, steps, order of steps, and the like shown in the following embodiment are examples, and are not intended to limit the present disclosure.

### Embodiment

Hereinafter, a vulnerability analysis system according to an embodiment will be described.

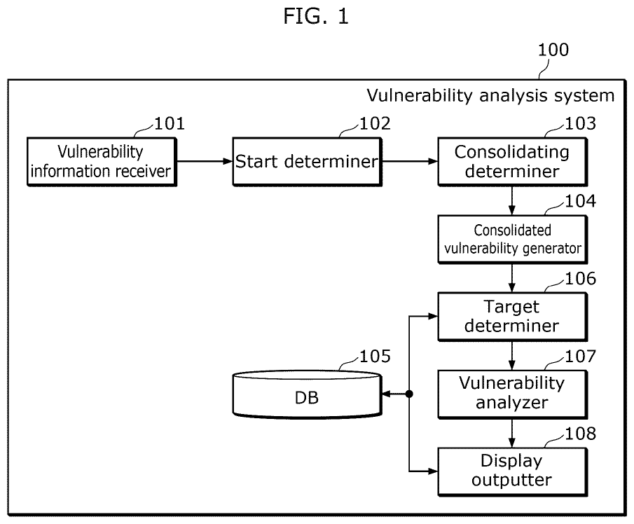

FIG. 1 is a block diagram illustrating an example of vulnerability analysis system 100 according to an embodiment.

Vulnerability analysis system 100 is a system that analyzes vulnerabilities of monitoring targets. The monitoring targets are not particularly limited, but for example, vulnerability analysis system 100 monitors equipment such as home appliances or vehicles, parts included in the equipment, or software for controlling the equipment or the parts. For example, vulnerability information may be received continuously, such as when multiple reports are intensively made for software indicated by the same CPE. Hereinafter, vulnerability analysis system 100 that can efficiently analyze continuously received vulnerability information will be described.

Vulnerability analysis system 100 includes vulnerability information receiver 101, start determiner 102, consolidating determiner 103, consolidated vulnerability generator 104, DB 105, target determiner 106, vulnerability analyzer 107, and display outputter 108. Vulnerability analysis system 100 is a computer including a processor (microprocessor), memory, and the like. The memory is a read only memory (ROM), random access memory (RAM), and the like, and can store programs executed by the processor. Vulnerability information receiver 101, start determiner 102, consolidating determiner 103, consolidated vulnerability generator 104, target determiner 106, vulnerability analyzer 107, and display outputter 108 are realized by a processor that executes a program stored in a memory, or the like. DB 105 may be stored in the memory in which the program is stored, or in a memory separate from the memory in which the program is stored.

For example, vulnerability analysis system 100 may be a computer (device) housed within a single enclosure, or may be a system consisting of multiple computers. In addition, for example, vulnerability analysis system 100 may be a server. It should be noted that the components included in vulnerability analysis system 100 may be placed on one server, or may be distributed and placed on multiple servers.

Vulnerability information receiver 101 receives vulnerability information regarding vulnerability of the monitoring target. For example, vulnerability information receiver 101 receives vulnerability information regarding various vulnerabilities of software of various equipment (for example, vehicles) from a vulnerability information public database such as National Vulnerability Database (NVD).

For example, the vulnerability information may include Common Vulnerabilities and Exposures (CVE) and the like. CVE is a database that assigns unique names and numbers to vulnerabilities. By using CVE, a unique name and number can be assigned to each vulnerability, making it easier to compare vulnerabilities.

It should be noted that the vulnerability information may include software information indicating software that is subject to the vulnerability indicated by the vulnerability information. For example, the same software is software indicated by the same software identifier, such as the same CPE, Software ID (SWID) tag, or Package URL (PURL). In addition, the vulnerability information may include countermeasure information indicating a countermeasure for the vulnerability indicated by the vulnerability information. In addition, the vulnerability information may include a Common Vulnerability Scoring System (CVSS) score or an Exploit Prediction Scoring System (EPSS) score of the vulnerability indicated by the vulnerability information.

For example, by determining whether the vulnerability indicated by the received vulnerability information is a vulnerability of the monitoring target that vulnerability analysis system 100 monitors, vulnerability information receiver 101 can use only vulnerability information regarding the vulnerability of the monitoring target for subsequent processing without using vulnerability information regarding vulnerabilities other than the monitoring target for subsequent processing. For example, vulnerability information receiver 101 can make the above determination by comparing the received vulnerability information with a registered Software Bill Of Materials (SBOM).

Start determiner 102 determines whether a predetermined period of time has passed since the vulnerability information was received. The predetermined period of time is not particularly limited, and is, for example, one hour, one day, or the like.

Consolidating determiner 103 waits for a predetermined period of time after vulnerability information is received, and when new vulnerability information is received while waiting, consolidating determiner 103 determines whether two or more items of vulnerability information that can be analyzed collectively are included in the plurality of items of vulnerability information received before the predetermined period of time elapses after the first vulnerability information is received. It should be noted that the first vulnerability information is, for example, vulnerability information that is received for the first time after vulnerability analysis system 100 starts waiting for reception of vulnerability information in order to perform vulnerability analysis. For example, consolidating determiner 103 may determine whether the plurality of items of vulnerability information include two or more items of vulnerability information for the same software. In addition, for example, consolidating determiner 103 may determine whether the plurality of items of vulnerability information include two or more items of vulnerability information with matching countermeasures. In addition, for example, consolidating determiner 103 may determine whether the plurality of items of vulnerability information include two or more items of vulnerability information that have the same tendency on CVSS score or EPSS score.

Consolidated vulnerability generator 104 generates consolidated vulnerability information obtained by consolidating two or more items of vulnerability information.

DB 105 is a database containing information for identifying monitoring targets. For example, DB 105 includes an SBOM that describes software and the like to be monitored by vulnerability analysis system 100. In addition, DB 105 may include analysis results by vulnerability analyzer 107, which will be described later.

Target determiner 106 identifies equipment (for example, a vehicle) that is a target of the consolidated vulnerability information, which will be described later.

Vulnerability analyzer 107 analyzes vulnerability information. When vulnerability analyzer 107 analyzes the consolidated vulnerability information generated by consolidated vulnerability generator 104, vulnerability analyzer 107 collectively analyzes two or more items of vulnerability information included in the consolidated vulnerability information (specifically, two or more items of vulnerability information among the plurality of items of vulnerability information received before a predetermined period of time elapses).

Start determiner 102, consolidating determiner 103, consolidated vulnerability generator 104, target determiner 106, and vulnerability analyzer 107 are examples of analyzers.

Display outputter 108 outputs the analysis results by vulnerability analyzer 107. For example, display outputter 108 may output and store the analysis results to a memory in which DB 105 is stored, or may output and display the analysis results to a display or the like. Display outputter 108 is an example of an outputter.

Next, details of the operation of vulnerability analysis system 100 will be explained.

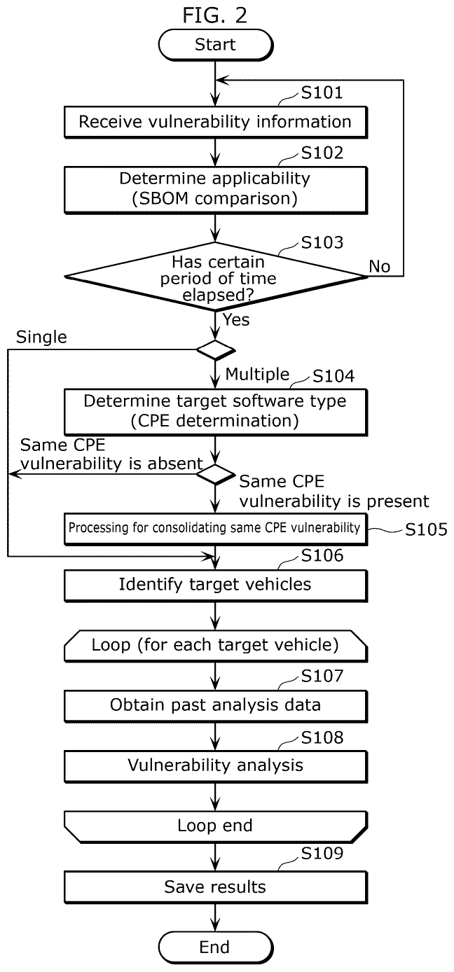

FIG. 2 is a flowchart illustrating an example of the operation of vulnerability analysis system 100 according to the embodiment.

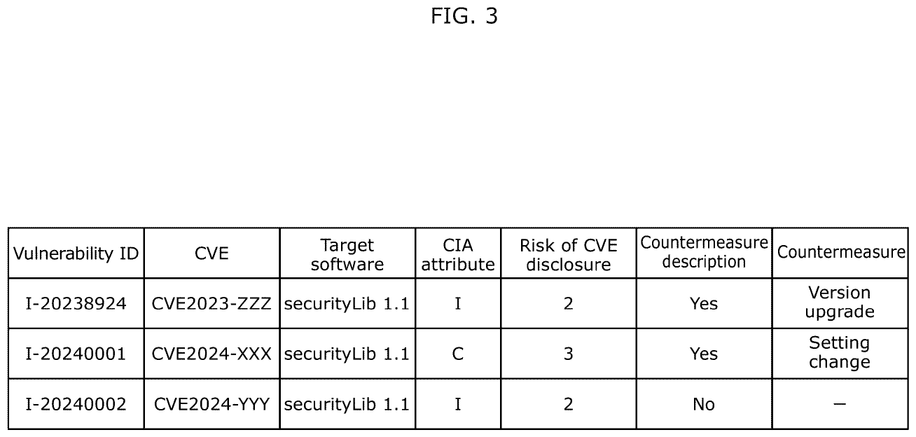

First, vulnerability information receiver 101 receives vulnerability information such as CVE from NVD or the like (step S101). Here, an example of vulnerability information will be explained with reference to FIG. 3.

FIG. 3 is a diagram illustrating an example of vulnerability information.

As illustrated in FIG. 3, the vulnerability information includes, for example, the vulnerability ID, CVE, target software, CIA attribute, risk described in the CVE, presence or absence of countermeasure description, and countermeasure. CIA stands for Confidentiality, Integrity and Availability. It should be noted that the received vulnerability information may not include all the detailed information as illustrated in FIG. 3, but only needs to include at least information that can identify the vulnerability (for example, CVE). The detailed information on the identified vulnerability may be stored in vulnerability analysis system 100 or in an external system. When the detailed information is stored in an external system, vulnerability analysis system 100 may check the detailed information to the external system.

Returning to the explanation in FIG. 2, vulnerability information receiver 101 determines whether the vulnerability indicated by the received vulnerability information corresponds to the vulnerability of the monitoring target by comparing the registered SBOM with the CPE and the like of the received vulnerability information (step S102). For example, when the CPE of the received vulnerability information is written in the registered SBOM, it is determined that the vulnerability indicated by the received vulnerability information corresponds to the vulnerability of the monitoring target. When the vulnerability indicated by the received vulnerability information does not correspond to the vulnerability of the monitoring target, the vulnerability information is not used in subsequent processing. When the vulnerability indicated by the received vulnerability information corresponds to the vulnerability of the monitoring target, the vulnerability information is used for subsequent processing.

Next, start determiner 102 determines whether a predetermined period of time has elapsed since the vulnerability information was received (step S103). If a predetermined period of time has not elapsed since the vulnerability information was received (No in step S103), vulnerability information receiver 101 waits to receive new vulnerability information, and when receiving new vulnerability information, vulnerability information receiver 101 determines whether the vulnerability indicated by the received new vulnerability information corresponds to the vulnerability of the monitoring target.

It should be noted that if new vulnerability information is received while waiting, start determiner 102 may extend the predetermined period of time. Since the predetermined period of time is extended each time vulnerability information is received, it is possible to prevent a plurality of continuous items of vulnerability information from not being completely received within the predetermined period of time.

If a predetermined period of time has elapsed since the vulnerability information was received (Yes in step S103), and if a plurality of items of vulnerability information are received and the plurality of items of vulnerability information include a plurality (two or more) of items that correspond to the vulnerability of the monitoring target, the processing in step S104 and step S105 is performed, and then the processing in step S106 is performed. It should be noted that if no vulnerability information corresponding to the vulnerability of the monitoring target is received, the processing ends.

Consolidating determiner 103 determines the type of software (e.g., CPE) targeted by the vulnerability indicated by the vulnerability information, which is included in each of the plurality of items of vulnerability information received before a predetermined period of time has elapsed (step S104), and determines whether the plurality of items of vulnerability information includes two or more items of vulnerability information for the same software (e.g., software indicated by the same CPE). For example, assume that the plurality of received items of vulnerability information includes three items of vulnerability information illustrated in FIG. 3. In this case, since each of the three items of vulnerability information targets “securityLib 1.1”, which is software indicated by the same CPE, consolidating determiner 103 determines that the received plurality of vulnerability information includes three items of vulnerability information that target the software of the same CPE.

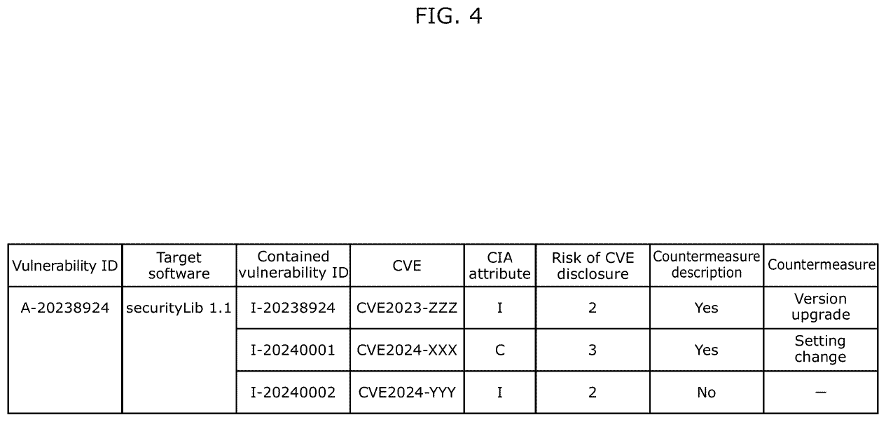

If it is determined that the plurality of the received items of vulnerability information includes two or more items of vulnerability information for software of the same CPE, consolidated vulnerability generator 104 performs processing of consolidating two or more items of vulnerability information for the same software (specifically, software indicated by the same CPE) among the plurality of received items of vulnerability information (step S105). For example, consolidated vulnerability generator 104 generates consolidated vulnerability information in which the two or more items of vulnerability information are consolidated. Here, an example of consolidated vulnerability information will be explained with reference to FIG. 4.

FIG. 4 is a diagram illustrating an example of consolidated vulnerability information.

The consolidated vulnerability information illustrated in FIG. 4 is a consolidation of the three items of vulnerability information illustrated in FIG. 3. Specifically, since the three items of vulnerability information target the software “securityLib 1.1” indicated by the same CPE, these three items of vulnerability information are consolidated to generate consolidated vulnerability information with the vulnerability ID “A-20238924” as illustrated in FIG. 4. Management can be made more efficient by handling two or more items of vulnerability information as one consolidated vulnerability information. It should be noted that although an example is shown in which the target software is written in CPE, this is just an example, and it may be written in other ways.

Although an example of consolidating two or more items of vulnerability information for the same software has been described here, the method of consolidating two or more items of vulnerability information is not limited thereto.

For example, consolidating determiner 103 may determine the countermeasure for the vulnerability indicated by the vulnerability information, which is included in each of the plurality of items of vulnerability information received before a predetermined period of time has elapsed, and may determine whether the plurality of the vulnerability information includes two or more items of vulnerability information that have matching countermeasures. If it is determined that the plurality of received items of vulnerability information includes two or more items of vulnerability information that have matching countermeasures, consolidated vulnerability generator 104 may generate consolidated vulnerability information in which the two or more items of vulnerability information that have matching countermeasures among the plurality of received vulnerability information are consolidated.

In addition, for example, consolidating determiner 103 may determine the CVSS score or EPSS score of the vulnerability indicated by the vulnerability information, which is included in each of the plurality of items of vulnerability information received before a predetermined period of time has elapsed, and determine whether the plurality of items of vulnerability information includes two or more items of vulnerability information with the same tendency on the CVSS score or EPSS score. If it is determined that the plurality of received items of vulnerability information includes two or more items of vulnerability information with the same tendency on the CVSS score or EPSS score, consolidated vulnerability generator 104 may generate consolidated vulnerability information in which two or more items of vulnerability information with the same tendency on the CVSS score or EPSS score among the plurality of received items of vulnerability information.

In addition, for example, consolidating determiner 103 may determine whether vulnerability information is consolidated based on any combination of the above conditions, and consolidated vulnerability generator 104 may generate consolidated vulnerability information.

Returning to the explanation in FIG. 2, if only one item of vulnerability information is received and the vulnerability information corresponds to the vulnerability of the monitoring target, or if a plurality of items of vulnerability information are received and the plurality of items of vulnerability information include only one item of vulnerability information that corresponds to the vulnerability of the monitoring target, the processing in steps S104 and S105 is not performed, and the processing in step S106 is performed.

Target determiner 106 identifies vehicles that are targets of the consolidated vulnerability information. For example, DB 105 includes an SBOM corresponding to each vehicle, and target determiner 106 identifies one or more vehicles to be targeted by comparing the CPE described in the CVE and the like of the consolidated vulnerability information and the CPE described in the SBOM corresponding to each vehicle. It should be noted that DB 105 may include an SBOM corresponding to each vehicle group configured by one or more vehicles, and target determiner 106 may identify one or more vehicle groups by comparing the CPE described in the CVE of the consolidated vulnerability information and the CPE described in the SBOM corresponding to each vehicle group. There are no particular limitations on how vehicle groups are configured, and vehicle groups may be configured according to records of response status, vehicle groups may be configured according to region, model, year, or the like, or vehicle groups may be configured according to any combination thereof. Then, the processing in step S107 and step S108 is performed for each target vehicle type corresponding to the identified vehicle or vehicle group. It should be noted that when two or more vehicles or vehicle groups are identified in step S106, the processing of step S107 and step S108 is performed for each vehicle or vehicle group.

It should be noted that target determiner 106 may identify a vehicle or a vehicle group that is a target of the vulnerability information that has not been consolidated (referred to as individual vulnerability information), and the vehicle or vehicle group may be identified by comparing the CPE described in the CVE of the individual vulnerability information and the CPE described in the SBOM.

Vulnerability analyzer 107 reads out and obtains past analysis data of the vehicle that is the target of the consolidated vulnerability information or the individual vulnerability information from the accumulator in which past analysis data is accumulated (step S107). It should be noted that when analysis is performed each time, vulnerability analyzer 107 may read only vehicle information, vehicle configuration information, and electronic control unit (ECU) information. In this case, past analysis data may not be accumulated.

Next, vulnerability analyzer 107 analyzes the consolidated vulnerability information or the individual vulnerability information (step S108). For example, vulnerability analyzer 107 generates a threat scenario and calculates feasibility and impact.

In this way, when new vulnerability information is received while waiting for a predetermined period of time after the first vulnerability information is received, vulnerability analyzer 107 collectively analyzes two or more items of vulnerability information among the plurality of items of vulnerability information received before the predetermined period of time elapses after the first item of vulnerability information is received.

For example, vulnerability analyzer 107 may collectively analyze two or more items of vulnerability information for the same software (for example, software indicated by the same CPE) among the plurality of items of vulnerability information. When a plurality of vulnerabilities for the same software are discovered and reported in a concentrated manner, two or more items of vulnerability information for the same software can be efficiently analyzed. For example, it is possible to efficiently analyze two or more items of vulnerability information for software indicated by the same CPE.

It should be noted that vulnerability analyzer 107 may collectively analyze two or more items of vulnerability information that have matching countermeasures among the plurality of items of vulnerability information. In this case, two or more items of vulnerability information that have matching countermeasures are analyzed collectively, making it easier to implement countermeasures. In addition, vulnerability analyzer 107 may collectively analyze two or more items of vulnerability information having the same tendency on the CVSS score or EPSS score among the plurality of items of vulnerability information. In this case, since two or more items of vulnerability information having the same tendency are analyzed collectively, continuously received vulnerability information can be analyzed more efficiently.

Then, display outputter 108 stores the analysis results (step S109). It should be noted that display outputter 108 may display the analysis results. For example, display outputter 108 may output (e.g., record or display) the analysis results of the consolidated vulnerability information and the analysis results of the individual vulnerability information, respectively.

As explained above, since two or more items of vulnerability information that are continuously received while waiting for a predetermined period of time are analyzed collectively, it is possible to efficiently analyze the vulnerability information that is continuously received. For example, since two or more items of vulnerability information are analyzed collectively, it is possible to analyze the mutual impact of each vulnerability. In addition, since two or more items of vulnerability information are analyzed all at once, the processing load can be reduced and the analysis results can be easily handled.

### Other Embodiments

As described above, the embodiment has been described as an example of the technology according to the present disclosure. However, the technology according to the present disclosure is not limited thereto, and can also be applied to embodiments in which changes, replacements, additions, omissions, or the like are made as appropriate. For example, the following variations are also included in the embodiment of the present disclosure.

For example, vulnerability analyzer 107 may collectively analyze a plurality of specified items of vulnerability information separately from a plurality of items of vulnerability information received before a predetermined period of time has elapsed. Accordingly, when a set of vulnerabilities necessary to implement a certain attack is specified, vulnerabilities corresponding to that set can be evaluated all at once.

For example, vulnerability analyzer 107 may individually analyze a plurality of items of vulnerability information. That is, in parallel with the analysis of the consolidated vulnerability information, each of the plurality of items of vulnerability information may be analyzed individually. This allows the analysis results of each vulnerability to be used in determining countermeasure policies. For example, it is possible to prioritize addressing vulnerabilities that pose a high risk alone.

For example, display outputter 108 may output two or more items of vulnerability information used to obtain the analysis results of the consolidated vulnerability information. By outputting (for example, recording or displaying) the vulnerability information used in the analysis, it is possible to easily grasp vulnerabilities that cause risks and make subsequent processing more efficient.

For example, vulnerability analyzer 107 may analyze the degree of contribution of each of the two or more items of vulnerability information included in the consolidated vulnerability information to the analysis result of the consolidated vulnerability information, and display outputter 108 may assign and output the degree of contribution to the two or more items of vulnerability information used to obtain the analysis results. For example, the degree of contribution is determined depending on the degree of involvement in a high-risk threat scenario. Specifically, the degree of contribution is determined depending on whether a data flow diagram (DFD) has been changed, whether a changed path is used, or the contribution to a decrease in feasibility. This makes it possible to grasp vulnerability information that has a high degree of contribution to risk among the consolidated vulnerability information. That is, it is possible to easily grasp vulnerabilities requiring high priority attention.

For example, display outputter 108 may output to distinguish the vulnerability information with a larger degree of contribution from the vulnerability information with a smaller degree of contribution among the two or more items of vulnerability information included in the consolidated vulnerability information. For example, the display order, size, color, or the like of the vulnerability information with a larger degree of contribution may be changed compared to the vulnerability information with a smaller degree of contribution. This makes it easy to grasp vulnerabilities requiring high priority attention.

For example, in the above embodiment, an example was described in which it is determined whether the software is the same using the CPE, but instead of using the CPE, it may be determined whether the software is the same using other software identifiers such as SWID or PURL.

For example, the present disclosure can be realized not only as vulnerability analysis system 100 but also as a vulnerability analysis method including steps (processing) performed by the components included in vulnerability analysis system 100.

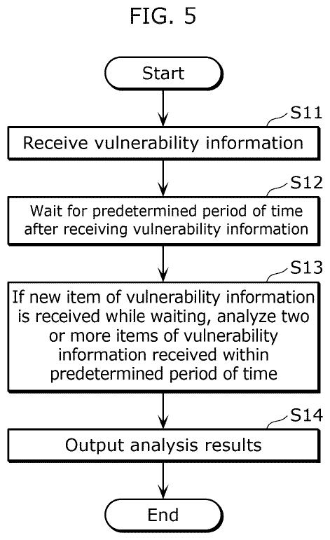

FIG. 5 is a flowchart illustrating an example of a vulnerability analysis method according to another embodiment.

As illustrated in FIG. 5, the vulnerability analysis method is a vulnerability analysis method executed by vulnerability analysis system 100 that analyzes vulnerability of the monitoring target, the vulnerability analysis method including: receiving vulnerability information regarding the vulnerability of the monitoring target (step S11); waiting for a predetermined period of time after the vulnerability information is received (step S12); collectively analyzing two or more items of vulnerability information among a plurality of items of vulnerability information that have been received before the predetermined time elapses when a new item of vulnerability information has been received while waiting (step S13); and outputting an analysis result in the analyzing (step 14).

For example, the present disclosure can be realized as a program for causing a computer (processor) to execute the steps included in the vulnerability analysis method. Furthermore, the present disclosure can be realized as a non-transitory computer-readable recording medium such as a CD-ROM on which the program is recorded.

For example, when the present disclosure is realized as a program (software), each step is executed by executing the program using hardware resources such as a computer's CPU, memory, and input/output circuits. That is, each step is executed by the CPU obtaining data from a memory, input/output circuit, or the like to perform calculations, and outputting the calculation results to the memory, input/output circuit, or the like.

It should be noted that in the above embodiment, each component included in vulnerability analysis system 100 may be configured with dedicated hardware, or may be realized by executing a software program suitable for each component. Each component may be realized by a program executor such as a CPU or a processor reading out and executing a software program recorded on a recording medium such as a hard disk or a semiconductor memory.

Some or all of the functions of vulnerability analysis system 100 according to the above embodiment are typically realized as an LSI, which is an integrated circuit. These may be integrated into one chip individually, or may be integrated into one chip so as to include some or all of them. In addition, circuit integration is not limited to LSI, and may be realized using a dedicated circuit or a general-purpose processor. A field programmable gate array (FPGA) that can be programmed after the LSI is manufactured, or a reconfigurable processor that can reconfigure the connections and settings of circuit cells inside the LSI may be used.

Furthermore, if an integrated circuit technology that replaces an LSI appears due to advances in semiconductor technology or another technology derived therefrom, that technology may naturally be used to integrate each component included in vulnerability analysis system 100.

In addition, forms obtained by applying various modifications to the embodiment conceived by a person skilled in the art or forms realized by arbitrarily combining the components and functions in each embodiment without departing from the spirit of the present disclosure are also included in this disclosure.

### (Additional Note)

The following technologies are disclosed by the description of the embodiments above.
(Technology 1) A vulnerability analysis system that analyzes vulnerability of a monitoring target, the vulnerability analysis system including: a vulnerability information receiver that receives vulnerability information regarding the vulnerability of the monitoring target; an analyzer that waits for a predetermined period of time after the vulnerability information is received, and when a new item of vulnerability information is received while waiting, collectively analyzes two or more items of vulnerability information among a plurality of items of vulnerability information that have been received before the predetermined period of time elapses; and an outputter that outputs an analysis result obtained by the analyzer.

According to this, two or more items of vulnerability information that are continuously received while waiting for a predetermined period of time are analyzed collectively, so it is possible to efficiently analyze the vulnerability information that is continuously received. For example, since two or more items of vulnerability information are analyzed collectively, it is possible to analyze the mutual impact of each vulnerability. In addition, since two or more items of vulnerability information are analyzed at once, the processing load can be reduced and the analysis results can be easily handled.
(Technology 2) The vulnerability analysis system according to technology 1, wherein the vulnerability information includes software information indicating software that is subject to the vulnerability indicated by the vulnerability information, and the analyzer collectively analyzes the two or more items of vulnerability information for same software among the plurality of items of vulnerability information.

According to this, when multiple discoveries and reports of vulnerabilities for the same software are performed in a concentrated manner, it is possible to efficiently analyze two or more items of vulnerability information for the same software.
(Technology 3) The vulnerability analysis system according to technology 2, wherein the same software is software indicated by same CPE, same SWID, or same PURL.

According to this, it is possible to efficiently analyze two or more items of vulnerability information for software indicated by the same software identifier such as the same CPE, SWID, or PURL.
(Technology 4) The vulnerability analysis system according to any one of technologies 1 to 3, wherein the vulnerability information includes countermeasure information indicating a countermeasure for the vulnerability indicated by the vulnerability information, and the analyzer collectively analyzes the two or more items of vulnerability information that have matching countermeasures among the plurality of items of vulnerability information.

According to this, two or more items of vulnerability information that have matching countermeasures are analyzed together, making it easier to implement countermeasures.
(Technology 5) The vulnerability analysis system according to any one of technologies 1 to 4, wherein the vulnerability information includes a CVSS score or an EPSS score of the vulnerability indicated by the vulnerability information, and the analyzer collectively analyzes the two or more items of vulnerability information that have a same tendency in the CVSS score or the EPSS score among the plurality of items of vulnerability information.

According to this, two or more items of vulnerability information having the same tendency are analyzed collectively, so vulnerability information that is received continuously can be analyzed more efficiently.
(Technology 6) The vulnerability analysis system according to any one of technologies 1 to 5, wherein the analyzer further generates consolidated vulnerability information in which the two or more items of vulnerability information are consolidated.

According to this, management can be made more efficient by handling two or more items of vulnerability information as one consolidated vulnerability information.
(Technology 7) The vulnerability analysis system according to any one of technologies 1 to 6, wherein the vulnerability information includes countermeasure information indicating a countermeasure for the vulnerability indicated by the vulnerability information, and the analyzer collectively analyzes the two or more items of vulnerability information that have matching countermeasures among the plurality of items of vulnerability information.

According to this, when a set of vulnerabilities necessary to implement a certain attack is specified, vulnerabilities corresponding to that set can be evaluated collectively.
(Technology 8) The vulnerability analysis system according to any one of technologies 1 to 7, wherein the analyzer further individually analyzes the plurality of items of vulnerability information.

According to this, in parallel with the analysis of the consolidated vulnerability information, each of the plurality of items of vulnerability information may be analyzed individually, and the analysis results of each vulnerability can be used to determine the countermeasure policy. For example, it is possible to prioritize addressing vulnerabilities that pose a high risk alone.
(Technology 9) The vulnerability analysis system according to any one of technologies 1 to 8, wherein the analyzer extends the predetermined period of time when a new item of vulnerability information is received while waiting.

According to this, the predetermined period of time is extended each time vulnerability information is received, so it is possible to prevent a plurality of continuous items of vulnerability information from being completely received within the predetermined period of time.
(Technology 10) The vulnerability analysis system according to any one of technologies 1 to 9, wherein the outputter further outputs the two or more items of vulnerability information that have been used to obtain the analysis result.

According to this, by outputting (for example, recording or displaying) the vulnerability information used in the analysis, it is possible to easily grasp vulnerabilities that cause risks and make subsequent processing more efficient.
(Technology 11) The vulnerability analysis system according to technology 10, wherein the analyzer analyzes, for each of the two or more items of vulnerability information, a degree of contribution made by the item of vulnerability information to the analysis result, and the outputter adds the degree of contribution to the two or more items of vulnerability information that have been used to obtain the analysis result and outputs the two or more items of vulnerability information to which the contribution degree has been added.

According to this, it is possible to grasp vulnerability information that has a high degree of contribution to risk among the consolidated vulnerability information. That is, it is possible to easily grasp vulnerabilities requiring high priority attention.
(Technology 12) The vulnerability analysis system according to technology 11, wherein the outputter outputs the two or more items of vulnerability information while distinguishing an item of vulnerability information with a larger degree of contribution from an item of vulnerability information with a smaller degree of contribution among the two or more items of vulnerability information.

According to this, it is possible to easily grasp vulnerabilities requiring high priority attention.
(Technology 13) A vulnerability analysis method executed by a vulnerability analysis system that analyzes vulnerability of a monitoring target, the vulnerability analysis method including: receiving vulnerability information regarding the vulnerability of the monitoring target; waiting for a predetermined period of time after the vulnerability information is received; collectively analyzing two or more items of vulnerability information among a plurality of items of vulnerability information that have been received before the predetermined time elapses when a new item of vulnerability information has been received while the waiting; and outputting an analysis result obtained in the analyzing.

According to this, it is possible to provide a vulnerability analysis method that can efficiently analyze continuously received vulnerability information.

### Further Information About Technical Background to This Application

The disclosure of the following patent application including specification, drawings, and claims is incorporated herein by reference in its entirety: Japanese Patent Application No. 2025-051874 filed on Mar. 26, 2025.

### Industrial Applicability

The present disclosure can be applied to systems and the like for analyzing vulnerabilities.

1. A vulnerability analysis system that analyzes vulnerability of a monitoring target, the vulnerability analysis system comprising:
a vulnerability information receiver that receives vulnerability information regarding the vulnerability of the monitoring target;
an analyzer that waits for a predetermined period of time after the vulnerability information is received, and when a new item of vulnerability information is received while waiting, collectively analyzes two or more items of vulnerability information among a plurality of items of vulnerability information that have been received before the predetermined period of time elapses; and
an outputter that outputs an analysis result obtained by the analyzer.

2. The vulnerability analysis system according to claim 1, wherein
the vulnerability information includes software information indicating software that is subject to the vulnerability indicated by the vulnerability information, and
the analyzer collectively analyzes the two or more items of vulnerability information for same software among the plurality of items of vulnerability information.

3. The vulnerability analysis system according to claim 2, wherein
the same software is software indicated by same Common Platform Enumeration (CPE), same Software Identification (SWID), or same Package URL (PURL).

4. The vulnerability analysis system according to claim 1, wherein
the vulnerability information includes countermeasure information indicating a countermeasure for the vulnerability indicated by the vulnerability information, and
the analyzer collectively analyzes the two or more items of vulnerability information that have matching countermeasures among the plurality of items of vulnerability information.

5. The vulnerability analysis system according to claim 1, wherein
the vulnerability information includes a Common Vulnerability Scoring System (CVSS) score or an Exploit Prediction Scoring System (EPSS) score of the vulnerability indicated by the vulnerability information, and
the analyzer collectively analyzes the two or more items of vulnerability information that have a same tendency in the CVSS score or the EPSS score among the plurality of items of vulnerability information.

6. The vulnerability analysis system according to claim 1, wherein
the analyzer further generates consolidated vulnerability information in which the two or more items of vulnerability information are consolidated.

7. The vulnerability analysis system according to claim 1, wherein
the analyzer further collectively analyzes a plurality of items of vulnerability information that have been specified, separately from the plurality of items of vulnerability information that have been received before the predetermined period of time elapses.

8. The vulnerability analysis system according to claim 1, wherein
the analyzer further individually analyzes the plurality of items of vulnerability information.

9. The vulnerability analysis system according to claim 1, wherein
the analyzer extends the predetermined period of time when a new item of vulnerability information is received while waiting.

10. The vulnerability analysis system according to claim 1, wherein
the outputter further outputs the two or more items of vulnerability information that have been used to obtain the analysis result.

11. The vulnerability analysis system according to claim 10, wherein
the analyzer analyzes, for each of the two or more items of vulnerability information, a degree of contribution made by the item of vulnerability information to the analysis result, and
the outputter adds the degree of contribution to the two or more items of vulnerability information that have been used to obtain the analysis result and outputs the two or more items of vulnerability information to which the contribution degree has been added.

12. The vulnerability analysis system according to claim 11, wherein
the outputter outputs the two or more items of vulnerability information while distinguishing an item of vulnerability information with a larger degree of contribution from an item of vulnerability information with a smaller degree of contribution among the two or more items of vulnerability information.

13. A vulnerability analysis method executed by a vulnerability analysis system that analyzes vulnerability of a monitoring target, the vulnerability analysis method comprising:
receiving vulnerability information regarding the vulnerability of the monitoring target;
waiting for a predetermined period of time after the vulnerability information is received;
collectively analyzing two or more items of vulnerability information among a plurality of items of vulnerability information that have been received before the predetermined time elapses when a new item of vulnerability information has been received while the waiting; and
outputting an analysis result obtained in the analyzing.
